(19) United States
(12) Patent Application Publication
(10) Pub. No.: US 2010/0158303 A1
(43) Pub. Date: Jun. 24, 2010

(54) AUDIO SYSTEM WITH CRADLE FOR PORTABLE MEDIA PLAYER

(76) Inventor: Kin Man Tse, Kwai Chung (HK)

Correspondence Address: LEYDIG VOIT & MAYER, LTD, 700 THIRTEENTH ST. NW, SUITE 300, WASHINGTON, DC, 20005-3960, US

(21) Appl. No.: 12/341,227

(22) Filed: Dec. 22, 2008

(51) Int. Cl. H04R 1/02; H04M 1/00

(52) U.S. Cl. 381/386; 455/556.1

(57) ABSTRACT

An audio system includes a housing; circuitry in the housing for processing signals from a portable media player connected to the housing; a pair of speakers connected to the circuitry and mounted to the housing; a cradle for receiving a portable media player; at least one connector fixed to the cradle for removably fastening the portable media player to the cradle and electrically connecting the portable media player to the circuitry; and a pivot located between the speakers and connecting the cradle to the housing for pivoting movement of the cradle relative to the housing, between first and second orientations substantially ninety degrees apart.

### TECHNICAL FIELD

The present invention relates generally to an audio system with a cradle for coupling portable media players.

### BACKGROUND OF THE INVENTION

Portable media players are becoming increasingly popular for storing and playing digital media, such as audio tracks, digital images, and videos. These portable media players typically include a small rectangular display and an output port, allowing them to be connected for audio output to stereophonic headphones or to an audio system including stereophonic speakers. Manufacturers provide these players in a range of storage capacities and physical dimensions in accordance with user preference.

A prior art audio system includes a fixed cradle for connection to the audio outlet port and speakers. Because the power output of portable media players is typically relatively low, a battery-powered amplifier may be used for powering the speakers. This audio system is relatively compact and readily portable. To achieve the stereophonic effect the cradle is be positioned centrally on the device, with one speaker to either side so that listeners can perceive directionality, for example, from the left or right, while viewing the small screen.

One drawback of conventional cradles however, is their inability to accommodate both the wide variety of shapes and sizes of portable multimedia players as well as their different orientations. Many applications employing the display of the portable media player are “directional”, as they are best viewed with the screen orientated in a particular direction e.g. with the longitudinal dimension of the display horizontal or vertical. This issue is insignificant to the user when the media player is held in the hand, as the whole device is simply rotated. However, by fixing the media player in a conventional cradle this element of flexibility is removed. It is an object of the present invention to overcome or substantially ameliorate the above disadvantages or more generally to provide an improved audio system for use with portable media players.

### DISCLOSURE OF THE INVENTION

According to one aspect of the present invention there is provided an audio system for a portable media player comprising:

a housing;

circuitry in the housing for processing signals from a portable media player connected to the housing;

a pair of speakers connected to the circuitry and mounted to the housing;

a cradle for receiving a portable media player;

at least one connector fixed to the cradle for removably fastening the portable media player to the cradle and electrically connecting the portable media player in communication with the circuitry, and

a pivot located between the speakers and connecting the cradle to the housing for pivoting movement of the cradle relative to the housing between first and second orientations substantially ninety degrees apart.

Preferably the housing includes first and second housing parts defining therebetween a recess for receiving the portable media player and wherein the housing parts are telescopically connected for varying the size of the recess.

Preferably the housing substantially has the form of a trapezoidal prism wherein the recess breaches the prism's major parallel face and one of the inclined faces of the prism.

Preferably the recess is located centrally relative to the longitudinal axis of the major parallel face.

Preferably the recess is adapted to receive a portable media player bounded by four rectangular edges, wherein the recess has two parallel transverse edges intersecting the major parallel face and formed on the first and second housing parts respectively, the transverse edges being joined by a longitudinal edge, the transverse and longitudinal edges being complementary to, and lying adjacent to, the edges of the portable media player in the first and second orientations.

Preferably the first and second housing parts have respective front edges aligned transversely and intersecting the major parallel face, the front edges lying adjacent one another and being spaced apart when the first and second housing parts are relatively telescopically retracted and extended respectively, the front edges being arranged symmetrically either side of a transverse plane bisecting the housing.

Preferably concavities are provided behind the transverse and longitudinal edges for receiving the corners of the portable media player as it is rotated between the first and second orientations.

Preferably the connector comprises a plug or socket defining a connector axis and spaced from the connector in the direction of the connector axis the cradle includes a pair of opposing lips having a re-entrant shape for holding the portable media player.

Preferably the lips are formed on a first retaining member removably connected to the cradle. Preferably the system further includes a second retaining member on which the lips are spaced apart by a dimension different from that by which the lips of the first retaining member are spaced apart, in order to accommodate a different model of portable media player.

Preferably the housing includes a battery compartment having battery-engaging electrical contacts connected to the circuitry and at least one foot mounted in a recess in the housing by a hinge disposed at one end of the foot.

This invention provides an audio system which is effective in operational use, which may be economically constructed and which is able to accommodate both the wide variety of shapes and sizes of portable multimedia players as well as their different orientations within a compact package.

### BRIEF DESCRIPTION OF THE DRAWINGS

Preferred forms of the present invention will now be described by way of example with reference to the accompanying drawings, wherein:

FIG. 1 is a front perspective view of an audio system according to a preferred embodiment of the invention showing the cradle and housing parts in their respective first positions;

FIG. 2 is a rear perspective view of the audio system of FIG. 1;

FIG. 3 is a front perspective view of the audio system of FIG. 1 showing a portable media player in dashed outline;

FIG. 4 is a front perspective view of the audio system of FIG. 1 showing the cradle and housing parts in their respective second positions;

FIG. 5 is a rear perspective view of the audio system of FIG. 4;

FIG. 6 shows a front view of the audio system of FIG. 1 showing the cradle and housing parts each in their first position;

FIG. 7 shows a front view of the audio system of FIG. 1 showing the cradle and housing parts each in their second position;

FIG. 8 shows an enlarged view of the connector of the audio system of FIG. 1;

FIG. 9 is a front perspective view of the audio system of FIG. 1 showing the cradle and housing parts in their first and second positions respectively;

FIG. 10 is a front perspective view of the audio system of FIG. 9 showing the cradle in a rotated position intermediate the first and second positions;

FIG. 11 is a perspective of two retainer members;

FIG. 12 is a perspective view of the base of the audio system of FIG. 1;

FIGS. 13 to 15 are perspective views of the pivot for the cradle of the audio system of FIG. 1 in the first position, intermediate position and second position respectively, and

FIG. 16 is a schematic of the electrical components of the audio system of FIG. 1.

### DESCRIPTION OF THE PREFERRED EMBODIMENTS

Referring to the drawings, the audio system includes a housing 10 having first and second housing parts 10a, 10b each enclosing a respective speaker 11. The speakers are disposed behind perforate covers 12 aligned in a common plane. Amplifier circuitry 14 located with the second housing parts 10a, 10b is connected to the speakers 14, to a battery 15 and to a connector 16. By electrically connecting the portable media player 28 via the connector 16 the system is able to output stereophonic audio from the portable media player 28.

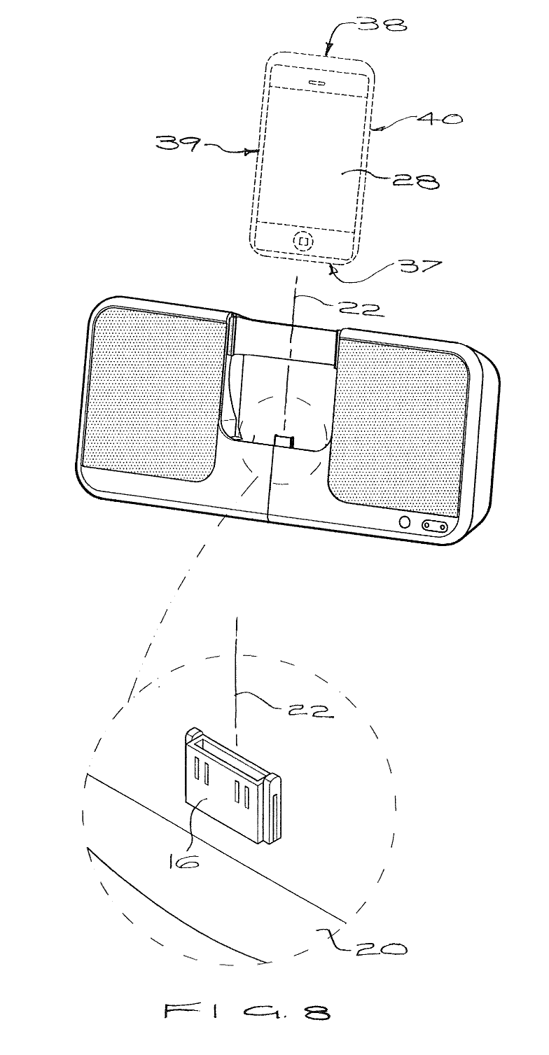

The connector 16 is fixed to a cradle 17 which is in turn connected to the second housing part 10b by a pivot (not shown) having a transverse pivot axis 19. The cradle 17 comprises a member 20 having a planar front face 21 at one end of which the connector 16 is fixed. The connector 16, in the preferred embodiment illustrated, comprises a multiple-pin socket compatible with a plug provided at the end of the portable media player 11. As best seen in FIG. 8, the connector 16 has a connector axis 22 aligned parallel to the face 21 and along which the portable media player 11 is moved such that the connector 16 is received in the portable media player, thereby providing a mechanical and electrical connection between the portable media player and the cradle.

Spaced from the connector 16 in the direction of the axis 22, the cradle 17 includes a first retaining member 23 removably connected to the member 20. Both the member 20 and first retaining member 23 are moulded polymeric components and are mutually connected as by a “snap-fit”, a connection by which an integral resilient detent on one engages a recess in the other. The first retaining member 23 includes a pair of opposing lips 24 having a re-entrant shape for holding the portable media player. A second retaining member 25 on which the lips 23 are more closely spaced can be used to replace the first retaining member 23 in order to accommodate a different model of portable media player (not shown).

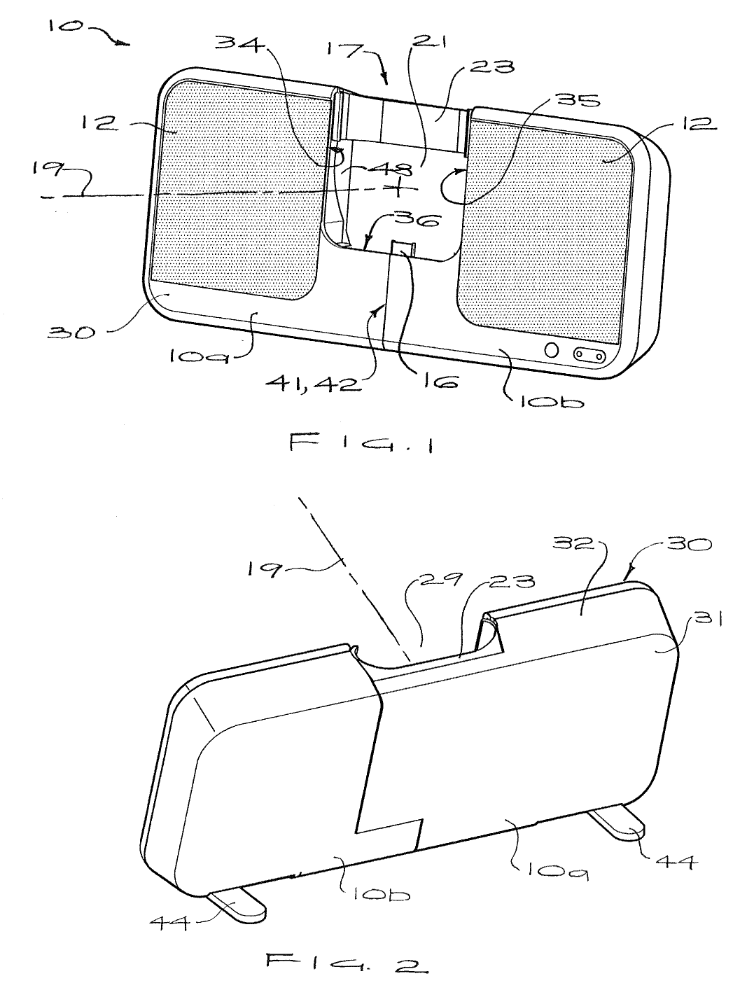

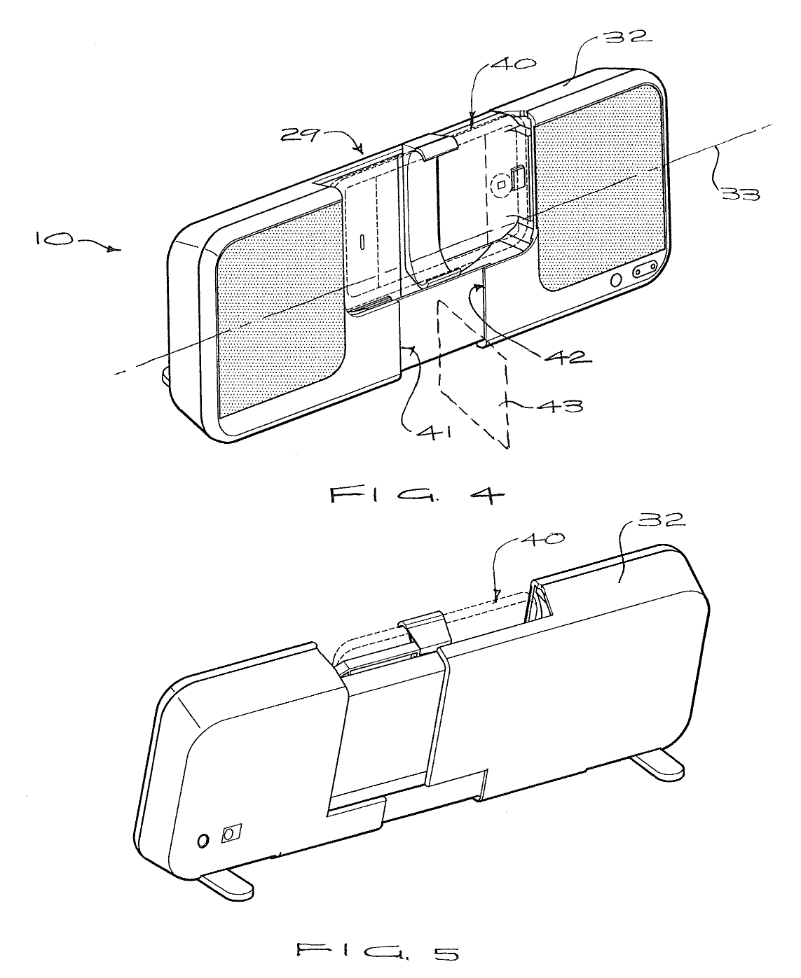

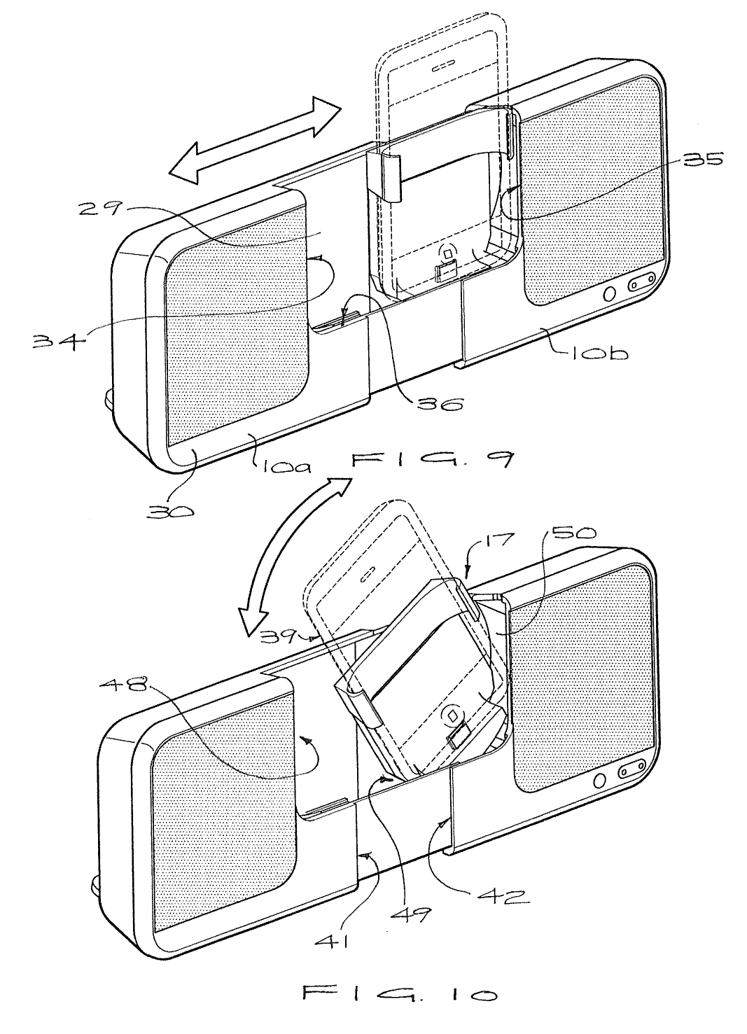

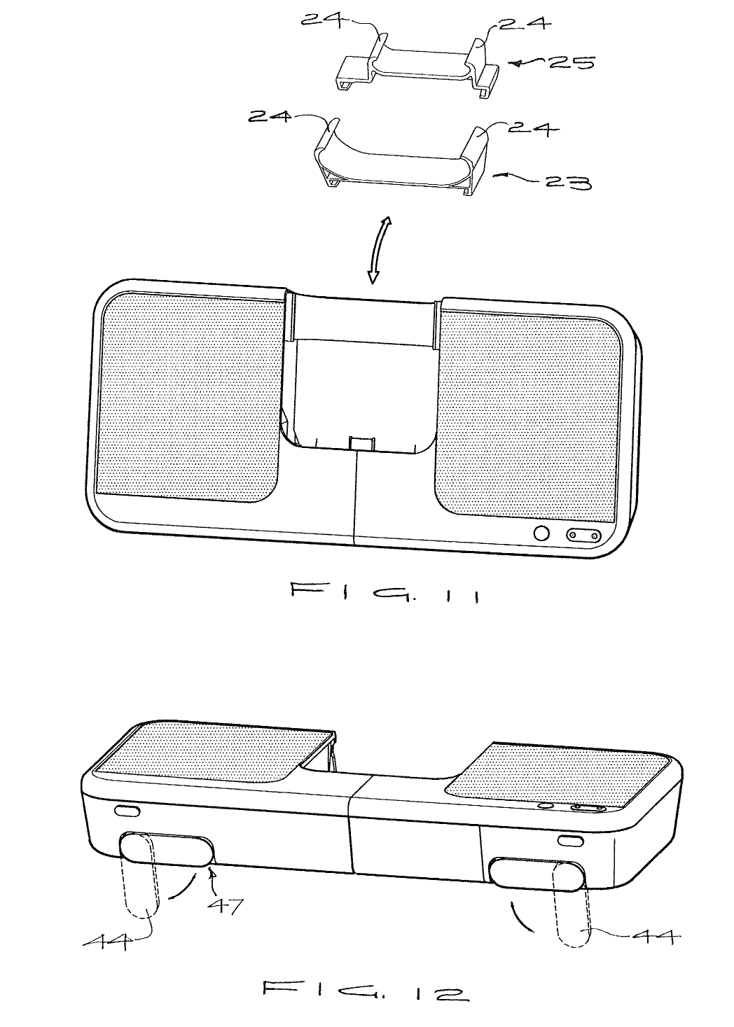

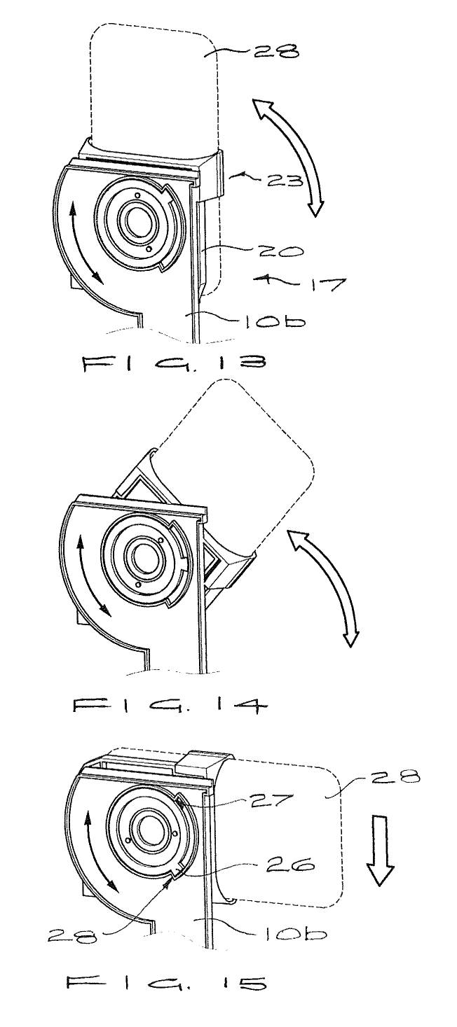

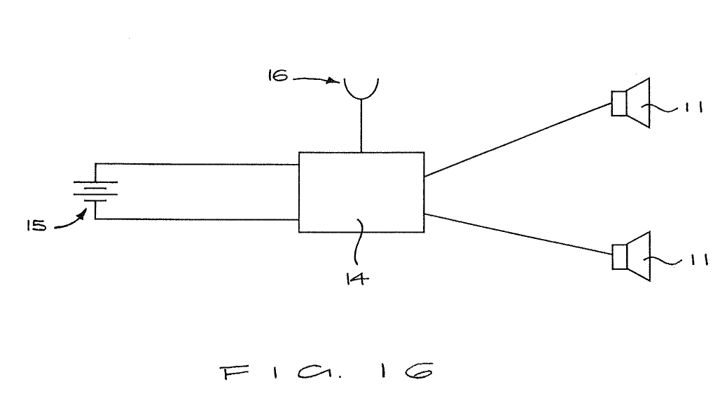

As best seen with reference to FIGS. 13-15, the pivot connecting the cradle 17 to the housing part 10b provides for pivoting movement of the cradle relative from a first orientation (FIGS. 1, 3, 6, 8, 9, 11, 13) past an intermediate position (FIGS. 10 and 14) to a second orientation (FIGS. 4, 5, 7 and 15) spaced ninety degrees from the first orientation. A tab 26 fixed to rotate with the cradle 17 abuts angularly spaced faces 27 on the housing part 10 to limit the rotation. In the first orientation the portable media player may be connected, inserting it firstly through the opening between the lips 24 before engaging the connector 16.

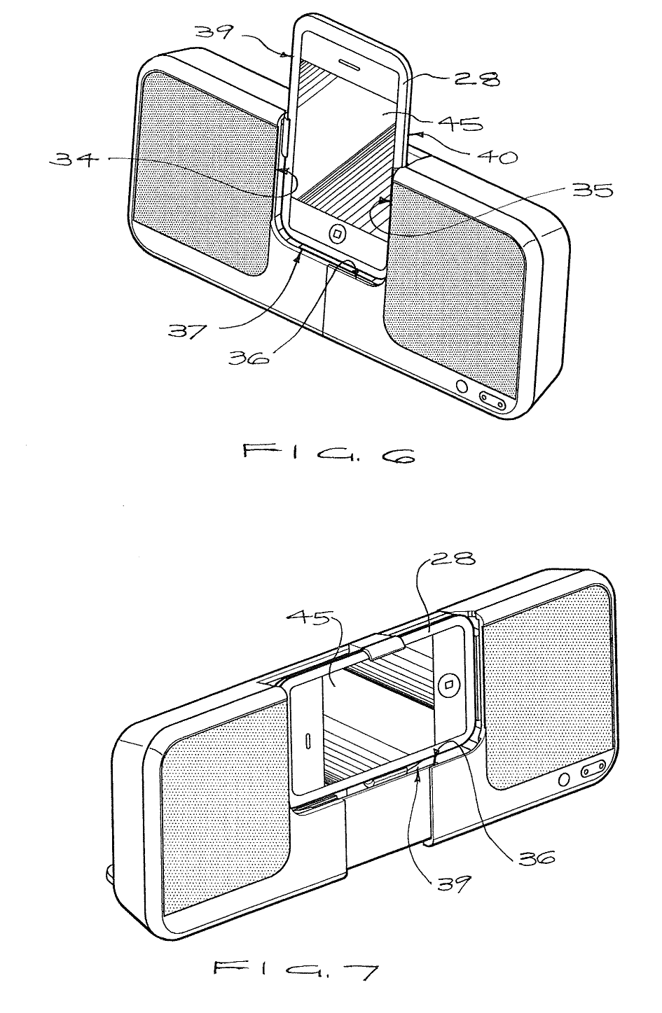

The portable media player 28, when connected to the system, is received in a recess 29 between the first and second housing parts 10a, 10b. The first and second housing parts 10a, 10b are telescopically connected in a manner allowing the size of the recess to be varied, so as to receive the portable media player in its different orientations, as best seen in FIGS. 6 and 7.

The housing 10 has the form of a trapezoidal prism in which the intersections between the faces are radiused. The major parallel face of the prism forms the front of the housing, and the perforate covers 12 lie in this major parallel face 30, while the minor parallel face 31 forms the rear of the housing 10. The recess 29 breaches the major parallel face 30 and the inclined face 32 extending between the faces 30 and 31 and defining the top of the housing 10. The major parallel face 30 is substantially rectangular, having a longitudinal axis 33. The recess 29 is located centrally located between the speakers 11 and covers 12, relative to the longitudinal axis 33 along which the housing parts 10a, 10b are mutually telescopically extendable. The recess 29 has two parallel transverse edges 34, 35 intersecting the major parallel face 30 and formed on the first and second housing parts 10a, 10b respectively. The transverse edges 34, 35 are joined by a longitudinal edge 36 part of which is formed on each of the first and second housing parts 10a, 10b. The portable media player 28 has four rectangular edges, including opposing short edges 37, 38 and long edges 39, 40. The transverse and longitudinal edges 34-36 are complementary to, and lie adjacent to, the edges of the portable media player.

In the first orientation the short edge 37 lies adjacent the longitudinal edges 36, and the portable media player shown projects from the recess 29, with the lower section received between the transverse edges 34 and 35. In the second orientation the short edge 37 is rotated to lie adjacent the transverse edge 35 while the short edge 38 lies adjacent the transverse edge 34. The portable media player shown is received completely in the recess 29, within the bounds of trapezoidal prism defined by the housing, and with the long edge 40 aligned with the inclined face 32.

Intersecting with the front face or major parallel face 30 the first and second housing parts 10a, 10b have respective front edges 41, 42 aligned transversely. The front edges lie adjacent one another (see FIG. 1) and are spaced apart (see FIG. 10) when the first and second housing parts are relatively telescopically retracted and extended respectively. The front edges 41, 42 are arranged symmetrically either side of a transverse plane 43 bisecting the housing 10.

A foot 44 is hingedly connected to the bottom of first and second housing parts 10a, 10b for supporting the audio system. Each foot 44 is mounted in a recess 47 in which it is located for storage, transport or the like. Each foot 44 lies in a plane parallel to the lower inclined face of the housing 10, so that the major parallel face 30 is inclined obliquely relative a horizontal support surface.

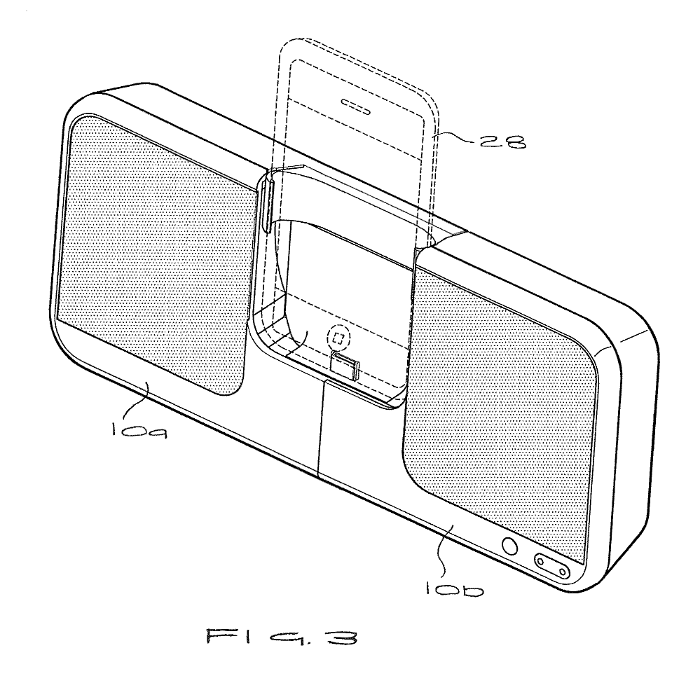

In use, with the audio system supported on the feet 44 on a horizontal surface the portable media player 28 may be conveniently inserted in the cradle 17, in the above-described manner, with the housing in its retracted position (FIGS. 1-3, 6 etc) and the cradle is in its first position. This provides the user with a conveniently small device to then view and operate the portable media player in an upright orientation as desired while playing audio through the speakers. For instance, the rectangular display 45 in this orientation may be convenient for viewing photographs, or the like.

If it is subsequently desired to rotate the portable media player to change the aspect ratio of the display, this is achieved by manually pulling the first and second housing parts 10a, 10b to configure the housing 10 in its extended position (FIGS. 4, 5, 9 etc) before rotating the portable media player and cradle 17 together to their second position. Concavities 48-50 are provided behind the transverse and longitudinal edges 34-36 for receiving the corners of the portable media player as it is rotated between the first and second orientations (as best seen in FIG. 10). In the second orientation the rectangular display 45 may be conveniently used for viewing video, for instance.

Aspects of the present invention have been described by way of example only and it should be appreciated that modifications and additions may be made thereto without departing from the scope thereof.

1. An audio system for a portable media player comprising:
a housing;
circuitry in the housing for processing signals from a portable media player connected to the housing;
a pair of speakers connected to the circuitry and mounted to the housing;
a cradle for receiving a portable media player;
at least one connector fixed to the cradle for removably fastening the portable media player to the cradle and electrically connecting the portable media player to the circuitry, and
a pivot located between the speakers and connecting the cradle to the housing for pivoting movement of the cradles relative to the housing, between first and second orientations that are substantially ninety degrees apart.

2. The audio system of claim 1 wherein the housing includes first and second housing parts defining therebetween a recess for receiving the portable media player, wherein the first and second housing parts are telescopically connected for varying size of the recess.

3. The audio system of claim 2 wherein
the housing has substantially a trapezoidal prism shape with a major parallel face with a longitudinal axis and an inclined face, and
the recess breaches the prism's major parallel face and one of the inclined faces of the prism.

4. The audio system of claim 3 wherein the recess is located centrally relative to the longitudinal axis of the major parallel face.

5. The audio system of claim 3, wherein the recess has two parallel transverse edges intersecting the major parallel face and located on the first and second housing parts, respectively, the transverse edges being joined by a longitudinal edge, the transverse and longitudinal edges being complementary to, and lying adjacent to, edges of the portable media player in the first and second orientations of the cradle.

6. The audio system of claim 3 wherein the first and second housing parts have respective front edges aligned transversely and intersecting the major parallel face, the front edges lying adjacent one another and being spaced apart when the first and second housing parts are relatively telescopically retracted and extended, respectively, the front edges being arranged symmetrically at opposite sides of a transverse plane bisecting the housing.

7. The audio system of claim 5 including concavities located behind the transverse and longitudinal edges for receiving corners of the portable media player as the cradle is rotated between the first and second orientations.

8. The audio system of claim 1 wherein
the connector comprises a plug or socket defining a connector axis and spaced from the connector in the direction of the connector axis, and
the cradle includes a pair of opposing lips having a re-entrant shape for holding the portable media player.

9. The audio system of claim 8 wherein the lips are located on a first retaining member removably connected to the cradle.

10. The audio system of claim 9 further including a second retaining member on which the lips are spaced apart by a dimension different from that by which the lips of the first retaining member are spaced apart.

11. The audio system of claim 1 wherein the housing includes a battery compartment having battery-engaging electrical contacts connected to the circuitry and at least one foot mounted in a recess in the housing by a hinge disposed at one end of the foot.

12 (canceled)
